(19) United States
(12) Patent Application Publication
(10) Pub. No.: US 2010/0313141 A1
(43) Pub. Date: Dec. 9, 2010

(54) System and Method for Learning User Genres and Styles and for Matching Products to User Preferences

(76) Inventors: Tianli Yu, San Mateo, CA (US); Orhan Camoglu, San Francisco, CA (US); Luca Bertelli, Foster City, CA (US); Jacquie Marie Phillips, San Mateo, CA (US); Muralidharan Venkatasubramanian, Mountain View, CA (US); Diem Vu, San Jose, CA (US); Munjal Shah, Palo Alto, CA (US); Salih Burak Gokturk, Palo Alto, CA (US)

Correspondence Address: MAHAMEDI PARADICE KREISMAN LLP, 550 Winchester Boulevard, Suite 605, SAN JOSE, CA, 95128, US

(21) Appl. No.: 12/792,704

(22) Filed: Jun. 2, 2010

Related U.S. Application Data
(60) Provisional application No. 61/183,968, filed on Jun. 3, 2009.
(60) Provisional application No. 61/396,790, filed on Jun. 1, 2010.

(51) Int. Cl. G06F 3/01; G06F 3/048

(52) U.S. Cl. 715/747; 715/810

(57) ABSTRACT

A fashion preference of a user is determined based on a user's interaction with a plurality of fashion product content items that individually depict a corresponding fashion product. A recommendation is made to a user of a fashion product based at least in part on the fashion preference of the user.

### RELATED APPLICATIONS

This application claims benefit of priority to Provisional U.S. Patent Application No. 61/183,968, entitled SYSTEM AND METHOD FOR LEARNING USER GENRES AND STYLES AND FOR MATCHING PRODUCTS TO USER PREFERENCES, filed on Jun. 3, 2009; the aforementioned priority application being hereby incorporated by reference in its entirety.

### BACKGROUND

Digital photography has become a consumer application of great significance. It has afforded individuals convenience in capturing and sharing digital images. Devices that capture digital images have become low-cost, and the ability to send pictures from one location to the other has been one of the driving forces in the drive for more network bandwidth.

Due to the relative low cost of memory and the availability of devices and platforms from which digital images can be viewed, the average consumer maintains most digital images on computer-readable mediums, such as hard drives, CD-Roms, and flash memory. The use of file folders are the primary source of organization, although applications have been created to aid users in organizing and viewing digital images.

On-line learning is a machine learning paradigm in which an algorithm learns from one instance or sample at a time. While off-line learning is composed of well established techniques that have been thoroughly dissected, on-line algorithms have received a lot of attention in the last decade, with several applications ranging from learning complex background and appearance models, object detection and classification, modeling and predicting user behavior. On-line learning can become the only viable solution in applications where the training data is never available in batch, but is gathered concurrently to the decision/classification process and hence the need to design an adaptive learning technique. On the other hand, off-line or batch paradigms need to be retrained once new/unseen data is presented.

Several on-line variants of the most popular off-line machine learning algorithms have been proposed in the literature. Some approaches have sought to address the problem of training Support Vector Machines (SVM) with large amount of data. Since training an SVM requires solving a Quadratic Programming in a number of coefficients equivalent to the cardinality of the training set, memory requirements can become the bottle-neck and therefore an on-line alternative is necessary. One approach has sought to introduce incremental decision tree classifiers that can be updated and retrained using new unseen data instances. Several contributions have been proposed to extend the popular AdaBoost algorithm to the online scenario, with several interesting variants ranging from Semi-Supervised Boosting to Multiple Instance Learning.

### BRIEF DESCRIPTION OF THE FIGURES

FIG. 1 illustrates a system that uses visual information to identify genre and fashion style preferences of a user, according to one or more embodiments.

FIG. 2 illustrates a method for predicting a preference of a user to a particular genre, according to one or more embodiments.

FIG. 3A depicts an example of a panel that can be generated to present a set of visual aids to the user in order to prompt the user into providing a response, under an embodiment.

FIG. 3B shows a panel that enables the user to select size information for various types of fashion products, such issues, tops, bottoms, and addresses.

FIG. 3C illustrates a panel that enables a user to specify or indicate the user's preference to characteristics patterns, color, and shape.

FIG. 4 describes a method for programmatically predicting the genre or style of a product, under an embodiment.

FIG. 5 illustrates a method for matching a product to a customer preference, according to one or more embodiments.

FIG. 6 illustrates a result panel for communicating the programmatically determine fashion genre preferences of the user, according to an embodiment.

FIG. 7 illustrates a method for determining descriptive classifications and categories of fashion products provided by fashion product content items, under one or more embodiments.

FIG. 8 illustrates a system that makes fashion product recommendations to users using product class/category determinations and user activity information, according to an embodiment.

### DETAILED DESCRIPTION

In fashion, people generally have their own unique preferences of style, color and genre of clothing. Their preferences as to genre and style is developed by their personal experience. For example, in a physical store, customers can describe their preferences and styles to a salesperson who can then recommend to them the right set of clothes and fashion accessories which match the customer's preferences. Embodiments recognize, however, that the same is not true for online shopping. In online shopping, a customer is forced to search and scan through many products for matching styles and preferences.

Accordingly, embodiments described herein provide a computer implemented method or system in which a user's genre preference to style or fashion can be determined programmatically.

Still further, embodiments enable programmatic classification and categorization of fashion products using image, text and metadata associated with a corresponding fashion product content item.

Still further, some embodiments enable a service or system to make programmatically determined recommendations relating top fashion products, based on information determined about the user's genre preferences and/or the determined genre of style of a fashion product represented by a content item.

More specifically, embodiments described herein include a computer-implemented method for determining user preferences for fashion products. In an embodiment, a fashion preference of a user is determined based on a user's interaction with a plurality of fashion product content items that individually depict a corresponding fashion product. A recommendation is made to a user of a fashion product based at least in part on the fashion preference of the user.

According to another embodiment, a fashion product content item is analyzed to determine a set of features of a fashion product depicted in the fashion product content item. The fashion product is associated with a pre-defined descriptive category for each of a plurality of descriptive classifications, based on a quantitative analysis of the determined set of features. The product content item and its pre-defined descriptive category for each of the plurality of descriptive classifications are used to determine or predict a user preference.

In another embodiment, one or more processors (such as provided in any computing environment, such as server-client) are structured to analyze individual fashion product content items representing a catalog of fashion products to determine, for each fashion product content item, a set of features of a fashion product depicted in that fashion product content item. Each fashion product represented by one of the fashion product content items is assigned to a pre-defined descriptive category for one or more corresponding descriptive classifications. The assignment is based on a quantitative analysis of the determined set of features. One or more fashion product content items are detected which are deemed to be of interested to the user. A fashion preference of the user is determined using the pre-defined descriptive category for each of the plurality of descriptive classifications of the one or more fashion product content items that are deemed of interest to the user.

Embodiments described herein include systems and methods for (i) learning a user's or customer's preferences in clothing styles, fashion and genres, (ii) predicting genres of different clothing products and fashion accessories, and/or (iii) using (a) known shopping parameters of a user (e.g. the user's size information, price preferences, hate or love for certain styles, patterns and colors) and/or (b) predicted genres and styles for each individual user, to propose the best matching products and accessories to customers.

A fashion product includes, for example, clothing, accessories and apparel. Specific examples include blouses, shirts, dresses, shoes, socks, pants and bottoms, belts, jewelry (e.g. watches, earrings, necklaces), ties, hats, jackets and coats.

A fashion product content item corresponds to a document or file that includes visual, textual and/or metadata information about a particular product. The fashion product content items are generally available as part of an online catalog or e-commerce search engine. Typical aspects of such content items include (i) one or more images of a product, (ii) textual information about the product, including information about available sizes and variations to the product, (iii) pricing information, and/or (iv) links or data elements to facilitate their viewer of the content item to purchase the depicted fashion product.

Some embodiments recognize that computational complexity and latency of all these on-line learning techniques remain an open problem and can become critical in time constrained applications such as real-time object tracking or the on-line shopping scenario that is described in this paper. In fact, a large number of high dimensional feature vectors enforces strict requirements on the number of operations allowed in order to meet the stringent time requirements.

Some embodiments described herein include computer-implemented techniques for learning user preferences from a user's interaction with an on-line interface (e.g. one provided at a shopping website). By predicting what the user likes, a better search ranking algorithm can be designed, which in turn results in a better experience perceived by the user. In terms of feature selection, embodiments combine heterogeneous cues coming from visual and text features and, in particular, provide a compact yet discriminative representation of the user's preferences that traditional features are not able to achieve. In addition, embodiments implement a learning stage which can process relatively large feature vectors in less then few milliseconds to avoid compromising the overall user experience.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or a module/component may be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources (including data ports, and signal lines (optical, electrical etc.), unless stated otherwise.

Embodiments described herein generally require the use of computers, including processing and memory resources. For example, systems described herein may be implemented on a server or network service. Such servers may connect and be used by users over networks such as the Internet, or by a combination of networks, such as cellular networks and the Internet. Alternatively, one or more embodiments described herein may be implemented locally, in whole or in part, on computing machines such as desktops, cellular phones, personal digital assistances or laptop computers. Thus, memory, processing and network resources may all be used in connection with the establishment, use or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

Learning Genre and Style Preferences of a Shopper

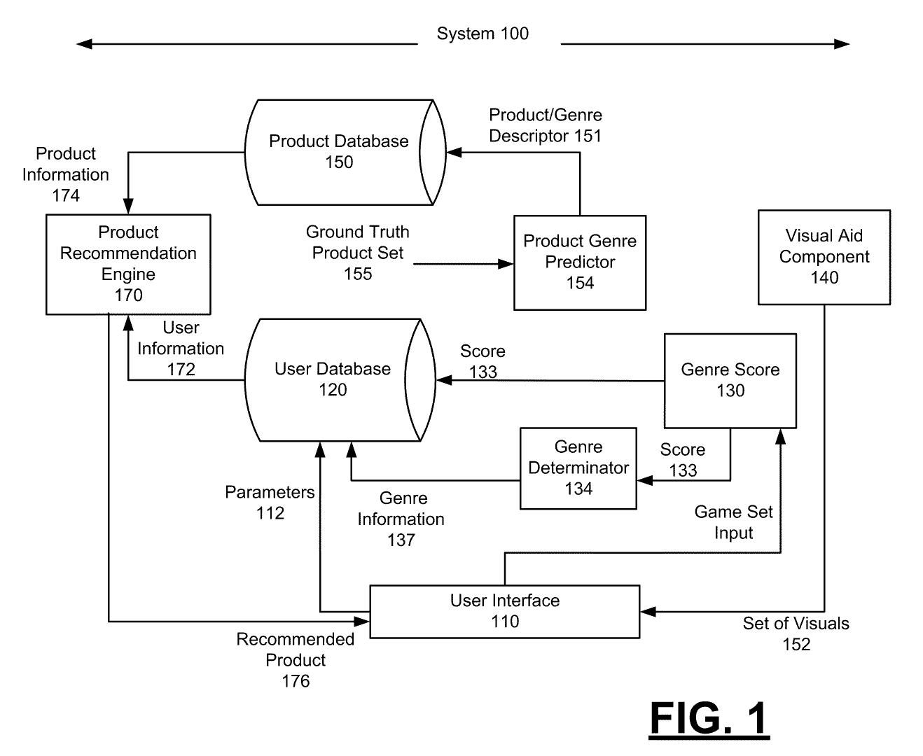

FIG. 1 illustrates a system that uses visual information to identify genre and fashion style preferences of a user, according to one or more embodiments. A system such as described in FIG. 1 presents pre-selected images of fashion products to individuals in an attempt to determine likes, dislikes, preferences and other user feedback for ascertaining the user's style or genre preference. In contrast to embodiments described, conventional techniques for estimating a shopper's (e.g. user or customer) style or genre preference typically involves asking the individual about genres/styles that best describe their personal preference to style and genre. However, the conventional approach is problematic-among the reasons, words are not sufficiently precisely to capture fashion preferences and statements. Additionally, users do not always know what their preferences are.

Accordingly, embodiments described herein and with FIG. 1 include a system that programmatically learns user fashion style and genre preferences using visual aids or pictures. The system 100 may be provided in a variety of computing environments, including in a client-server architecture. For example, system 100 may be implemented on one or more servers (or other computing machines) to provide a service such as described by one or more embodiments detailed herein. In this environment, system 100 may be implemented on a website, such as in a e-commerce site, search engine or shopping portal.

System 100 may rely on genre definitions that are defined by experts or operators. For example, fashion genres include (and are not limited to) ‘looks’ that are of the following genres: chic, street, Boho, urban/hip-hop, and conservative. For example, experts may select clothing and clothing in ensembles that are representative of the various categories (the number of which is set by design or choice). In some cases such representative clothing and clothing ensembles form ground truth data, or points of comparison, in determining (i) genre preferences of the user, and (ii) predicting the genre of another item of clothing or apparel. In an embodiment, a system 100 depicts images of clothing and clothing ensembles in a worn state. For example, images of people (including celebrity images) wearing different genres of clothes and accessories can be shown to the user. The user is enabled to respond to individual images to specify whether the depicted clothing is of a style or type that is in the user's preference. Thus the system can learn from user choices made on images, rather than on text descriptions or on user's self-reporting of preferences.

More specifically, system 100 includes a user-interface 110, a user database 120, a genre score component 130, a genre determinator 134, a visual aid component 140, and a product database 150. A user of system 100 may correspond to a shopper or a customer of fashion products. In some embodiments, system 100 is implemented on an online medium. For example, system 100 can be implemented as part of an e-commerce site, shopping portal, or other web-based or networked environment in which individuals are given the opportunity to view (and potentially purchase) fashion products. The interface 110 may correspond to, for example, a webpage, or interactive feature provided on a webpage.

The user of system 100 is associated with the profile in user database 120. For example, the user may have an account with an operator of a service that provides system 100. Alternatively, the user may be known by cookie/computer information, by account/login, or for a solitary online session with a provider (e.g. e-commerce site) of system 100. Independent of system 100 and determining style or genre preferences of the user, the user may interact with the interface 110 and provide parameters 112 relating to fashion products that the user can wear. The parameters that the user may specify include, for example, the user clothing size, preferred price range for fashion and clothing items, and preferred brand names. The user may also volunteer information about visual characteristics of clothing and apparel that the user likes or dislikes. For example, the user may specify preferred colors for certain types of clothing, preference information about fabrics or materials, preferred styles of shoes or apparel, types of jewelry, and aversions or preferences for particular types of patterns.

The product database 150 retains information from fashion product content items. As described with some embodiments, a product database 150 may store information about fashion products depicted in the product content items. Such information may be programmatically determined from image, text and metadata analysis of fashion product content items, as provided by retailers, manufacturers and other suppliers of fashion products. The information that is programmatically determined about depicted fashion products is associated in database 150 with corresponding product content items, such as electronic catalog pages and sections.

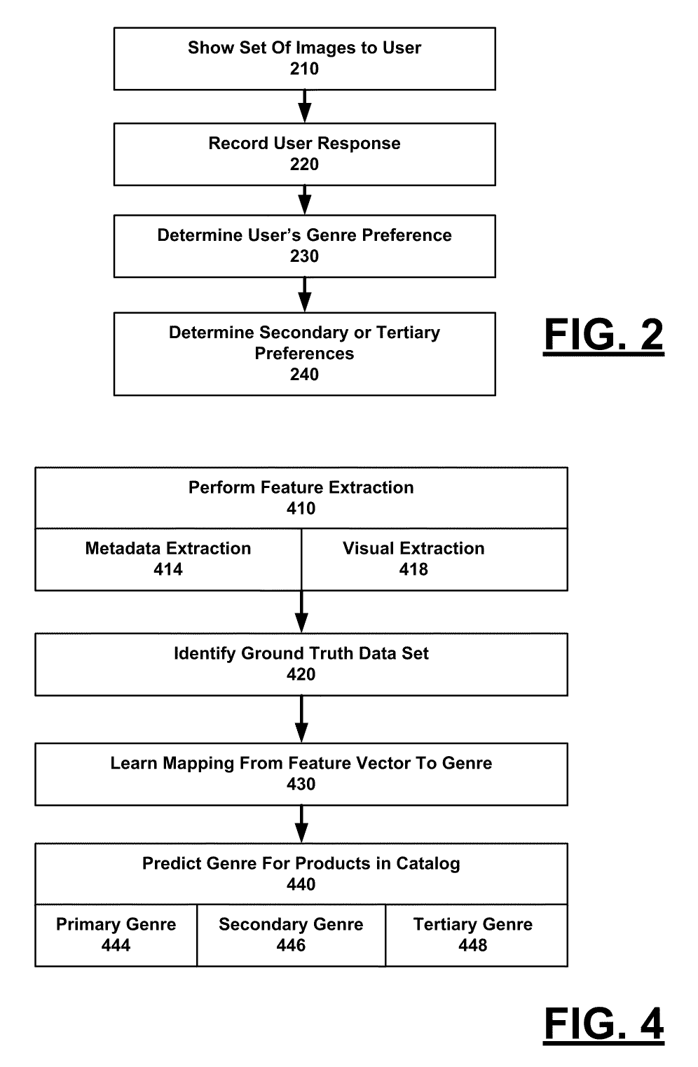

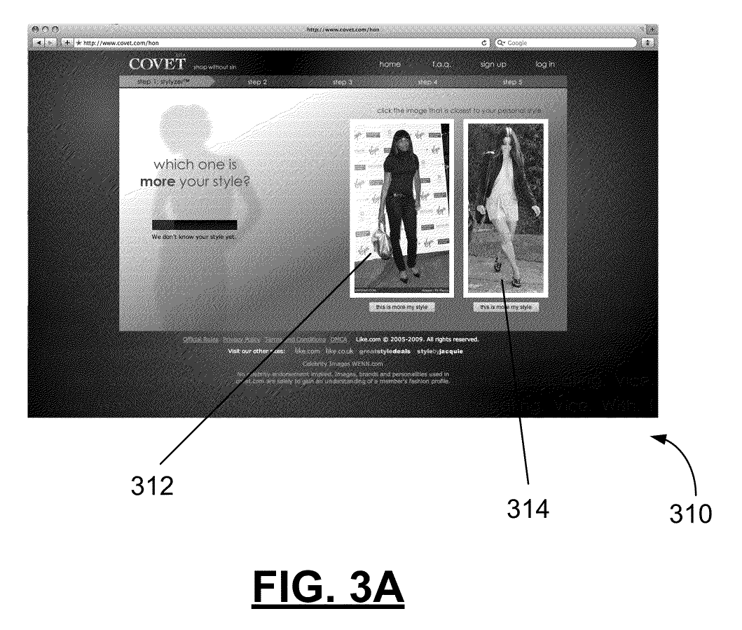

In order to programmatically determine genre/style preferences of the user, the visual aid component 140 is configured to present to the user images, or visual aids, from which are elicited to make the genre/style preference determinations. Visual aid component 140 communicates visuals 152 of fashion products to the user via the interface 110. In one embodiment, the visuals 152 depict fashion products, or ensembles of fashion products, in a worn state (e.g. as worn by a celebrity or model, on a mannequin, or computer generated onto an image of a person). FIG. 2 and FIG. 3A illustrate examples of how the visuals 152 can be structured for presentation to the user.

The user can provide input through the interface 110 that indicates (i) the users like or dislike of a particular fashion product or ensemble; (ii) the user's preference of one fashion product over another; and/or (iii) a rating or feedback that indicates the level of the user's like or dislike for the fashion product. The visual aid component 140 present a set of visuals 152 that prompt the user to enter a response that indicates the users visual preference for the fashion genre depicted by that visual Still further, as described with an embodiment of FIG. 2 or FIG. 3A, the visuals may be presented to the user in a quiz or game fashion. In the quiz or game fashion, the user is shown panels that individually depict competing fashion products of different genres. The user can respond to each panel by indicating their preference, or like dislike, a one fashion product over at the other end of panel.

The genre score component 130 records and determines a genre score from the user's input. The genre score component 130 may record responses the user has too been presented in visuals 152, in order to score individual classifications of fashion genre. Optionally, the genre score component 130, in combination with the visual aid component 140, can record and score the users response to subcategories of fashion genre.

Numerous techniques may be employed to ascertain the fashion genre preferences of the user. In one embodiment, the set of visuals 152 is predesigned to depict a number of images of fashion products for each identify genre. The user simply responds with preference or like/dislike input when viewing images of the fashion products in order to indicate his likeness or preference of one fashion genre over another. The genre score component 130 maintains a genre score 133 that is indicative of the user's genre preference, for genres represented by this set of visuals 152. The genre score 133 can be recorded in the user database 120, in association with the profile from the user.

As an addition or alternative, the genre determinator 134 determines one or more preferred genres and/or subcategories (e.g. primary, secondary, and tertiary genres) of the user based at least in part on the score 133. The genre determinator 134 and/or score 133 may also influence the visuals 152 outputted for the user by the component 140, in that intelligence may be used by way of probabilistic assumptions that those users who have a certain genre preference are likely to have a particular like or dislike of another genre. For example, the user with business genre preference may be deemed unlikely to also like street genre clothing.

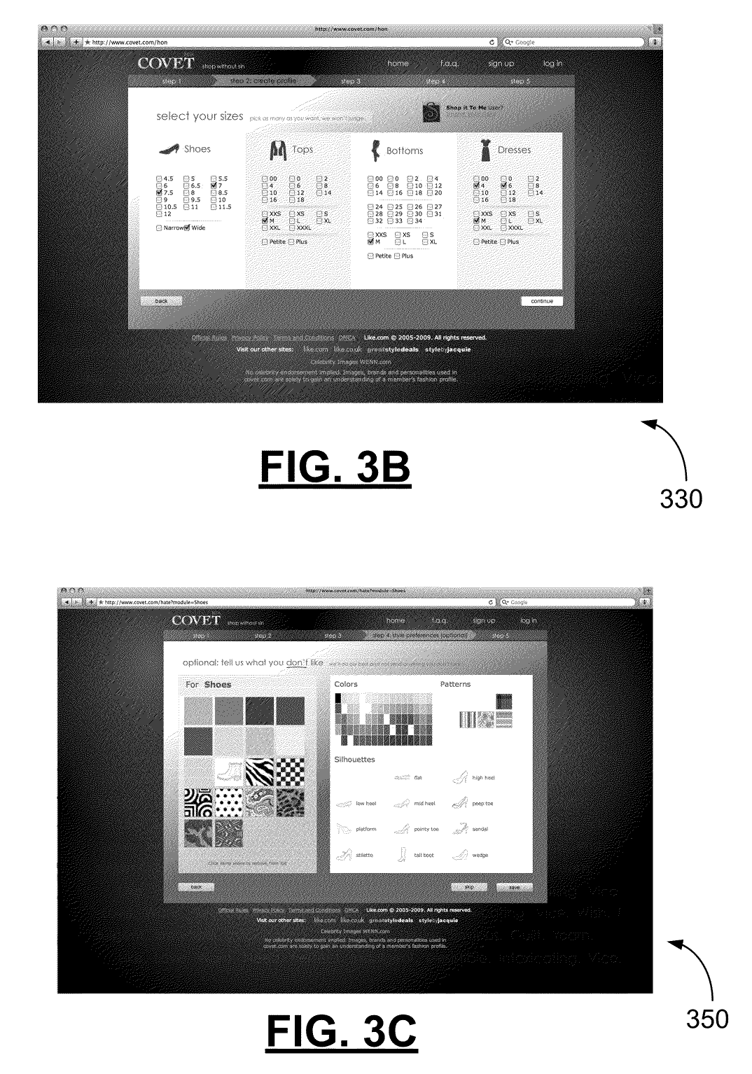

Additionally, one or more embodiments provide that the fashion products identified in the product database 150 are tagged with genre descriptors 151. The descriptors include programmatically determined genre descriptors, which can be determined by a product genre predictor component (PGPC) 154. In particular, PGPC 154 analyzes the product content items in order to obtain information that can be used to determine the genre(s) of the fashion product depicted in the content item. Thus, system 100 can used to determine genre preferences of the user, as well as to predict the genre classifications and categories of fashion products. The genre descriptors 151 determined from the PGPC may include sub-genres or genre categories, including secondary and tertiary genres determinations. For example, many fashion products may share more than one genre. FIG. 4 illustrates a method for predicting genre(s) of fashion products using fashion product content items, according to some embodiments. As described, may base its determination on learning behavior, using a ground truth product set 155 provided by operators of system 100.

In an embodiment, system 100 also includes a product recommendation engine 170. According to one or more embodiments, product recommendation engine 170 recommends a fashion product to the user, based on (i) user information that identifies genre/style preferences and parameters for fashion products that the user may purchase, and (ii) fashion product information. User information 172 is provided by user database 120. In particular, user information 172 is provided by genre preferences as outputted by the genre score component 133 and/or genre preference information 137. The fashion product information 174 is retrieved from the product database 150. The fashion product information 174 includes programmatically predicted genre classifications and/or subcategories, associated with individual products. The fashion product information 174 may also include information retrieved from the fashion product content item, as well as tag (e.g. metadata) provided by a supplier of the fashion product content item or the underlying fashion product. With user information and fashion product information, the recommendation engine 170 is able to recommend individual fashion products from, for example, products identified in the product database 150. The recommended products 176 may be communicated to the user via the interface 110.

Additionally, embodiments provide that system 100 is able to show its confidence in predicting user genres and style. As will be described, system 100 includes an interface in which users are able to also record known parameters, such as the user's clothing size, price preference, and/or their like/dislike for certain styles, patterns and colors. This information is used while matching products to user preferences. The overall system allows for multiple hierarchies of genre prediction: primary or top level genre predicting broad genre or style matches, secondary or second level genre predicting multiple fine-grain genre and styles, tertiary or third level genre predicting multiple domain specific styles, and so on.

FIG. 2 illustrates a method for predicting a preference of a user to a particular genre, according to one or more embodiments. More specifically, a method such as described determines, for a particular user, the user's primary, secondary and tertiary genres of preference. A method such as described may be implemented using a system such as described with FIG. 1. Accordingly, reference may be made to elements and numerals of FIG. 1 in order to describe suitable elements and components for performing a step or sub-step being described.

A set of images is shown to a user (210). In one embodiment, visual aid generator 140 selects and displays individual images of the set to the user via user-interface 110. The set of images can be pre-selected to be from a diverse range of genres. In one embodiment, some or all of the genres are determined using manual definitions and selections. Thus, the set of images may be sorted into different genres using manual input to classify each image in a particular genre. Alternatively, some or all of the images in the set are programmatically determined to be associated with a genre. For example, programmatic methods may be used to identify similarity between items of clothing, and the similarity comparisons may be used to associate clothing with a particular genre.

In response to being shown each image individually, the user is prompted to respond by providing an input (via interface 110) that indicates whether the user liked or disliked the image. The user's responses are recorded (220). In one implementation, the input is prompted from the user as part of a game in which the user can participate with input that states whether the user considered an individual image from the set as hot-or-not (“Hot-or-not game”).

Based on user input, the user's genre preference is determined (230). With reference to an embodiment of FIG. 1, genre determinator 134 determines a user's preference to genre. In an embodiment, the genre determinator 134 uses an algorithm to determine the user's genre preferences (e.g. primary, secondary and tertiary). In one embodiment, an algorithm is used as follows:

Denote the whole set of genres as S={Sᵢ, i=1 . . . n}, where n is the number of genres. Assume that each user has a predetermined set of favorable genres, denote as F={n, j=1 . . . m}. Also assume that a set of images, denoted as Tᵢ, is provided for each genre Sᵢ. Now assume that when the user is shown a pair of images (I₁, I₂) from different image set Tᵢ and Tⱼ, (i) if only one of them belongs to F (without loss of generality, assume it to be I₁), then the user has a higher probability p>0.5 to pick I₁; (b) if both images belongs to F or none of the images belong to F, the user picks either image randomly with a probability of 0.5.

The algorithm maintains a vector of probabilities estimation, denoted as Qᵣ=[qᵣ₁, qᵣ₂, . . . qᵣₙ], of the user to belong to each genre after each round r. After each style question in a round, the algorithm will update the user's genre probabilities. The update can be performed as follows: Of the two genres that are presented to the user, the one picked by the user is updated using

qᵣ₊₁=qᵣ*p (1)

The one that is not picked by the user is updated using

qᵣ₊₁=qᵣ*(1−p) (2)

All the rest of the genres are updated using

qᵣ₊₁=qᵣ*0.5 (3)

After the update, Qᵣ₊₁ is normalized so that the sum of all the probabilities equals to 1.

Based on the current genre probabilities, do one of the following:

1. If one of the genre probabilities is above a certain threshold, then the algorithm terminates the test and returns the best genre to the user.

2. If none of the genre probabilities are above the threshold, then the algorithm picks two genre images to be shown to the user in the next round.

Different strategies can be used to choose the two images for the next round of the test, such as: (i) Randomly pick two genres; and/or (ii) Pick the top two genres that have the highest probabilities (this strategy helps the probability converge to the correct guess faster and minimizes the number of image pairs shown to the user).

The algorithm can be generalized to present k (k>2) images to the user. In this case the update equation for (2) and (3) would be

qᵣ₊₁=qᵣ*(1−p)/(k−1) (4)

qᵣ₊₁=qᵣ*1/k (5)

The algorithm can also be generalized to determine t (t>1) genres. In this case, the criterion for stop can be modified to check the top t probabilities. The strategy to select the next set of images should pick images from both the top t genres and the rest of the genres.

According to an embodiment, the user's responses to indicating likes or dislikes are used to determine the primary, the secondary and the tertiary genres of preference for the user (240). The primary, the secondary and the tertiary genres of preference can be determined at the same time. One way to implement this is to sequentially predict the primary, secondary and tertiary genres. However, to minimize the number of images shown to the user (and hence reduce user amount of user response), an approximation algorithm can be used. If all the images used for primary genre prediction are also tagged with secondary and tertiary genres, then the images that the user selected during the primary genre prediction can be used to build multiple histograms—one for secondary genres and multiple (one per domain) for tertiary genres. The top genres in these histograms can be used to predict secondary and tertiary genres.

To offer good user experience, some embodiments provide for progress feedback to indicate the amount of progress the user has made towards the computer-learning of his genres of preference. In one embodiment, a progress bar can be shown to the user to indicate the progress of the genre prediction. The distance between the threshold and the current best genre probability, max qᵣᵢ, can be used as progress indicator.

FIG. 3A depicts an example of a panel that can be generated to present the visual aids 152 (FIG. 1) to the user in order to prompt the user into providing a response, under an embodiment. In FIG. 3A, panel 310 is presented through the interface 110 (see FIG. 1). Thus, for example, panel 310 may be formatted as a webpage. The panel 310 comprises a pair of images 312, 314 that each depict clothing (as worn by a celebrity or model) of a particular genre. The user can select one image over the other to indicate his preference of a particular genre depicted by that image (as compared to the genre depicted in the other image). Thus, the user's selection of one image over another is the input that indicates the user's preference of one genre over another. Once the user makes a selection, the visual aid component 140 presents another panel comprising another pair of images (depicting clothing of different genres) to the user in order to solicit a similar selection from the user. According to an embodiment, the comparison game between image pairs can continue for a number of rounds, with a user selection in each round providing information as to the user's like/dislikes of the various genres defined with system 100.

FIG. 3B shows a panel 330 that enables the user to select size information for various types of fashion products, such issues, tops, bottoms, and addresses. Parameters such as size can be used to make fashion product recommendations, filter recommendations to the user based on lack of availability of a given size, or skew the user's genre preference to accommodate a specific size or body type of the individual.

In addition to recording user feedback of genre selection (via competing images of clothing), some embodiments provide that the user is able to enhance or augment the genre determination with input that specify some preferences of the user. FIG. 3C illustrates a panel 350 that enables a user to specify or indicate the user's preference to characteristics patterns, color, and shape. The characteristics that the user can specify preferences for may be specific to a particular type of fashion product. For example, the shape preferences of the user can specify may be presented as being specific to the category of fashion products for shoes, or more specifically woman's shoes.

Associated and Ensemble Recommendations for Clothing, Apparel and Accessories

According to embodiments, an online commerce environment (such as implemented by a system of FIG. 1) implements a recommendation engine to recommend additional clothing, apparel, or accessories. Such recommendations may be made to, for example, provide a fashion ensemble or matching set of clothing/apparel.

In order to facilitate recommendation of clothing/apparel or accessories, one or more embodiments provide that at least some available products for a commerce medium are programmatically analyzed in order to predict the individual product's genre and style. FIG. 4 describes a method for programmatically predicting the genre or style of a product, under an embodiment.

Product genre prediction combines several different feature types, such as metadata features (based on textual description) and visual features (based on visual vocabularies computed from several thousand of images).

For individual products in a catalog, programmatic feature extraction can utilize different forms of features (410). The features extraction includes metadata extraction (414) and visual feature extraction (418). In metadata feature extraction, metadata features are identified and represented as a vector, where each word or word pair that appears in one of the metadata fields (such as title, description, brand, prices, etc.) represent one dimension in the vector. Visual features can be determined using image analysis, and represented as vectors. Here, the vector can represent one global feature computed over the whole image, or one based on visual vocabulary computed over thousands of images. These visual features include color, shape, and/or texture. A final feature vector can be computed by combining the metadata and visual vectors, for example, by concatenating metadata feature and visual features one after another to form a single big feature vector V.

A set of products are manually tagged by fashion experts with primary, secondary, and tertiary genre tags to form a ground truth set (420).

Machine learning algorithms (Support Vector Machine or boosting or Bayesian learning) are used to learn the mapping from the extracted feature vector to different genres for these products (430). For each genre, given the feature vector V, a binary classifier can be learned to determine the probability of a product to belong to that genre or not.

Genre prediction can then be performed for individual products that are not in the ground truth set (440). For each product, the probabilities of all genres are estimated and the top genres are selected as the genre predictions for that product.

To estimate all primary (444), secondary (446) and tertiary genre (448) for a product, a multilevel level classification can be performed in which secondary or tertiary genres are conditioned on the primary genre. Primary genre classifiers are trained as previously stated. Then, given the primary genre g₁ of a product, a new set of secondary g₂ and tertiary genre g₃ is trained for each primary genre g₁. During testing, the joint probability of primary and secondary/tertiary genres given the feature vector P(g₁ g₂ g₃|V) can be computed as

P(g₁g₂g₃|V)=P(g₁|V)*P(g₂|g₁V)*P(g₃g₂V) (6)

Product Matching

According to embodiments, product recommendations are made by (i) identifying predicted product genres of products (as described with FIG. 4), (ii) identifying a given user's genre or style preference for clothing and apparel (as described with an embodiment of FIG. 2); and (iii) matching product to user using (i) and (ii).

In some embodiments, products can be boosted for recommendation by boosting products which match user preferences to higher ranks and de-weighing products which do not match user preferences to lower ranks.

As described herein, products which do not match user preferences can be de-weighted as follows: (i) filter non-matching products completely from presentation to user, or (ii) down-weigh such towards the end of results. Matching products (or recommendations) can be viewed by user via period automatic emails (for example, emailed daily, twice in a week, once in a week, or once in a month) or by logging onto a website. Also, depending on how often a product has been shown to the user and how often user has clicked on it, the system keeps learning the user's overall genre and domain-specific genre preferences.

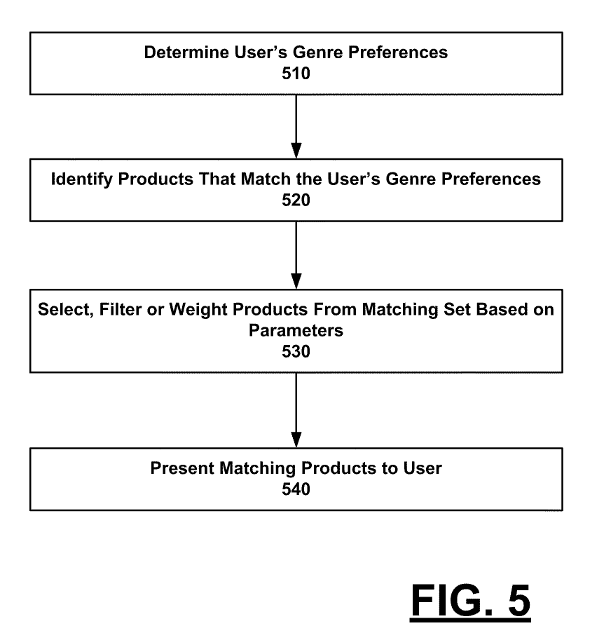

In more detail, FIG. 5 illustrates a method for matching a product to a customer preference, according to one or more embodiments. Reference is made to components of FIG. 1 in order to describe' suitable components for performing a step or sub-step being described.

The primary and secondary/tertiary genre combination with the highest joint probability can be select as the genres of the product.

For a given user, the user's primary, secondary and tertiary genres are identified (510). For example, the results of a process such as described by FIG. 2 may be analyzed or retrieved to determine the user's preference genres. The visual aid component 140 may present visuals 152 to prompt the user for a response. A series of prompts may be solicited from the user in order to have the user specify comparative preferences of various different genres. The resulting score (determined from the user's responses) is used to determine the user's fashion genre preferences.

Once a user's primary, secondary and tertiary genres of preference are identified, a pool of products are identified from the product database 150 that match the user's preferences (520).

In one embodiment, the matching products are subjected to a process of selection, filtering, are weighting, in order to identify a subset of fashion products to recommend to the user (530). For example, selection and filtering may be performed to exclude fashion products that are not available and the size of the user, or which are of a color, pattern or shape that the user has specified as being disliked. As another example, the matching products may be filtered to eliminate items that have the color, brand or keywords that the user does not like. The matching products may also be weighted to favor/disfavor fashion products that satisfy, for example, specified preferences of the user as to color, pattern, shape, or brand. Matching products can then be presented to the user as, for example, a search or browse list (540). In one embodiment, the remaining products are then sorted by a matching score to determine the order in which they should be sent to the user.

According to an embodiment, the matching score can be computed as a linear combination of different individual matching scores:

s=w₁a₁+w₂*a₂+ . . . where (wᵢ>0)

The individual matching score includes the product's primary, secondary or tertiary genre probabilities, age matching score, price preferences, and other color, style or pattern preferences.

Result Presentation

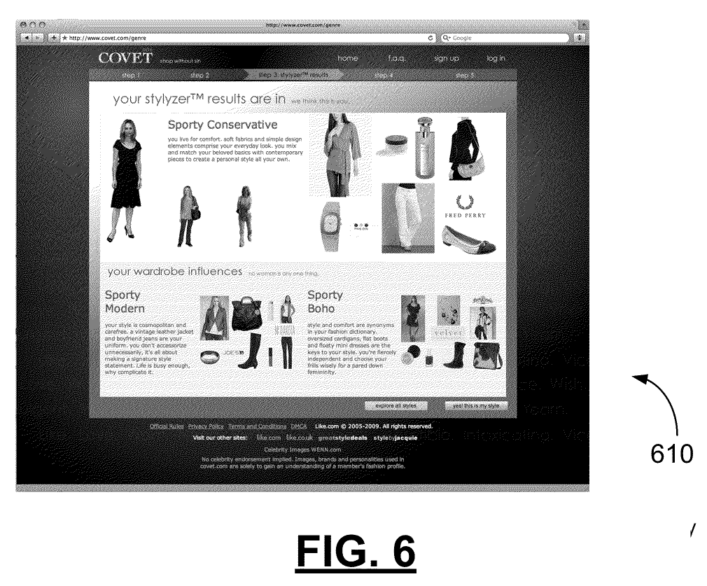

While results of various processes, algorithms and system output can be provided to user in various forms, some embodiments include an interactive tool that the user can use in order to determine the user's fashion genre preferences. FIG. 6 illustrates a result panel for communicating the programmatically determine fashion genre preferences of the user, according to an embodiment. A result panel 610 can be output in response to an individual partaking in, for example, a quiz or challenge generated through the visual aid component 140. Through processes such as described by various embodiments, result panel 610 may identify the user's primary genre (Sporty), and one of more secondary (Conservative) or tertiary genres (Modern, Boho). The result panel 610 may also display fashion products that meet the users genre/style preferences. The images of fashion products may be preselected, based on the images being deemed representative of the particular genre or genre combination. Alternatively, some or all of the fashion products depicted may be selected for the user. For example, parameters such as user specified color preferences may be used to present some items of clothing or apparel. Likewise, if a user prefers a certain style of shoes (e.g. boots, as specified by the user via an interface such as shown in FIG. 3C), footwear the result panel 610 may be depicted by boots.

Enhanced Feature Representation

Embodiments described herein may incorporate enhanced feature representation of descriptive classifications for fashion products. In particular, descriptive classifications can be defined by human operators (e.g. experts) to include multiple categories (or sub-classifications). According to embodiments, fashion product content items (e.g. catalog or web image of clothing) are analyzed to extract features from images, text and metadata. The extracted features are then analyzed to associate the fashion product with one of more descriptive classifications (of fashion products), and one or more categories are each associated descriptive classification.

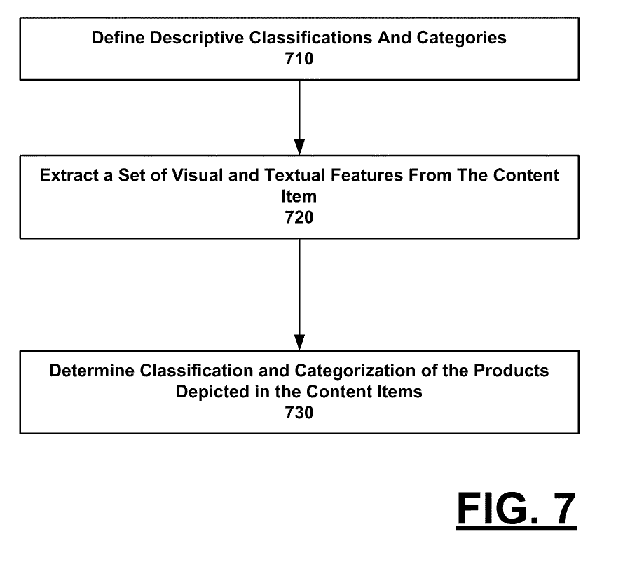

FIG. 7 illustrates a method for determining descriptive classifications and categories of fashion products provided by fashion product content items, under one or more embodiments.

Descriptive classifications and categories (or sub-classifications) for fashion products are defined by human operators (710). In one embodiment, the descriptive classifications include (but are not limited to): genre, shape or silhouette, pattern, and color. For example, the following classifications may be employed:
Genre Tags (GT): classic, trendy, edgy, boho, etc.
Silhouette Tags (ST): high heel, open toe, sleveless, turtleneck, etc.
Pattern Tags (PT): floral print, stripe, zebra print, etc.
Color Family Tags (CFT): light red, dark pink, etc.

For individual fashion product content items, a set of primitive visual and text features are extracted from the content item (720). These features include, for example, color histogram, shape descriptors, texture features and text description features. To determine such features, image recognition and text analysis (including textual metadata analysis) can be performed on individual content items.

Analysis is performed on the primitive features in order to determine the classification and categorization (or sub-classifications) of the products depicted in the content items (730). The analysis can be quantitative. More specifically, in one embodiment, the analysis can be statistical. Furthermore, multiple methods can be implemented to associate a fashion product with the classification. For color classification a set of cluster centers is created that is based on manually labeled ground truth. Each product (or image thereof) is assigned to the nearest cluster based on its distance in histogram space:

xᵢ^{CFT}=g(∥f−cᵢ∥) (1)

f is the primitive feature vector comprehensive of visual and textual information;

cᵢ with i=1, . . . N^{CFT} are cluster centroids for the color family/classification; and

Xᵢ^{CFT} are components of the color family hyper dimension x^{CFT}

g is a mapping from distances to likelihoods.

A support vector machine classifier (SVM) may be used to associate or assign the products to the classifications. For each classification, human operators (e.g. fashion experts) select a set of positive examples that possesses the properties corresponding to the tag, and a set negative examples that do not have those properties. As a new (unknown) item comes, the trained SVM is used to generate a decision value from the visual and text feature of the item. The decision value represents the item's distance to the separating hyperplane. Only the values on the positive side of the hyperplane are retained:

$${x}_{i}^{T} = 𝒯 ( {\sum }_{j = 1}^{N} {α}_{ij}^{T} {c}_{ij}^{T} κ ( {g}_{j} , f ) - {b}_{ij}^{T} ) \qquad ( 2 )$$

where αᵢ^{T}, cᵢ^{T}, bᵢ^{T} are the learned SVM parameters corresponding to each tag of each hyperdimension T ε{GT, ST, PT}. As before, f is the primitive feature vector of the item, while g₃ of all other items in the training set. \acute{K} is the kernel function and T(x)=xH(x), where H(x) is the Heaviside function.

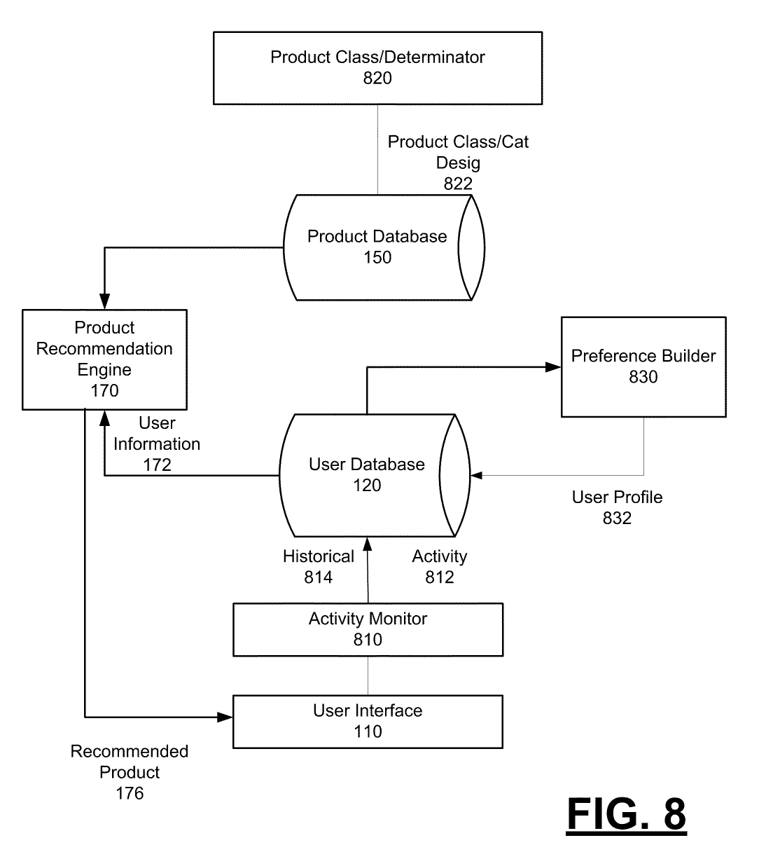

FIG. 8 illustrates a system that makes fashion product recommendations to users using product class/category determinations and user activity information, according to an embodiment. A system such as described by an embodiment of FIG. 8 may represent a modification or variations to an embodiment described in FIG. 1, as well as elsewhere in this application. Thus, functionality and components of FIG. 8 may optionally be viewed as supplementing or augmenting a system such as described with FIG. 1.

A system 800 may comprise the user database 120 and the product database 150. As described with other embodiments, the user database 120 may associate certain information with individual users, such as the users fashioned genre preferences (which may be programmatically determined) as well as parameters specified by the user (e.g. See FIG. 3B and FIG. 3C) in addition, the user database 120 may be coupled to a monitor component 810 that monitors or detects and user actions about fashion product content items and related activity. The monitor component 810 may detect activity such as one or more of the following: (i) user interaction with the search results, including the user selecting or otherwise indicating interest to a particular item in the search result; (ii) user interaction with online browsing or shopping environment. Information 812 that identifies items (e.g. products) of interest can be stored in the database 120. In one embodiment, this information 812 includes items that were displayed to the user and which the user clicked-on, as well as items that were displayed to the user and not clicked on.

The user monitor 810 may detect session specific activity, or historical activity 814 from the user's past sessions. The historical activity can extend to search terms that the user entered at, for example, a search engine or e-commerce site. The user interaction may be detected through interface 810, or through the browser or browser data (e.g. browser history and cookie information). In some embodiments, the historical activity 814 includes the queries that the user typed in, the impressions (i.e. the items retrieved by the search engine and presented to the user) and the buy clicks (i.e. the items clicked by the user). The set of queries, is projected onto the fashion-aware feature space described above and several positive training samples are obtained.

In an embodiment, the product database 150 is coupled to a product category/class determinator 820. The category/class determinator 820 may analyze fashion product content items in order to determine one or more classifications/categories 822 of each product. In an embodiment, the category/class determinator 820 implements a process such as described by FIG. 7. In an embodiment, the resulting descriptive classification/categorization is stored in the product database 150.

According to one or more embodiments, a user preference profiler 830 generates a user profile 832 based on activity information 812 and/or historical information 814. The profiler 830 updates the user profile 832 for individual users. In creating and updating the user profile 832, the profiler 830 (i) identifies fashion products from the user activity information 812 (e.g. products that the user selected to view when browsing or searching, products the user elected not to view)); (ii) uses the product database 150 to determine classifications and categorizations of those products (as determined by FIG. 7); and (iii) uses the descriptive classifications and categorizations of the products identified from the activity information 812 to develop the user's profile 832. The users profile 832 may augment, supplement or otherwise identify the fashioned genre preferences of the user. Thus, the user profile 832 may be combined with, or be used as an alternative, to the programmatic fashion genre determination described by other embodiments. For example, the user profile 832 may be session specific and robust to determine that the user is looking for an event-specific outfit (e.g. evening gown), which otherwise may not be in the preference genre of the user. The profiler 830 may also use the historical information 814 to develop the profile 832.

In one embodiment, the recommendation engine 170 is configured to recommend products 176 data selected for the user based at least in part on the genre preferences as identified by the user profile 832 and/or genre preferences identified via the aid/score component. The recommendation engine 170 may also include historical data 814 as a component for determining its recommended product 176. The recommendation engine 170 may also be used to recommend and/or retrieve and/or rerank products in response to user query/search or request for products from a specific type of fashion products

Short-Term Usage

Embodiments recognize that in an online scenario, the short-term preference of the user can become of importance. Embodiments further recognize a need for an online algorithm that quickly learns from the user's actions, and enhances the user's shopping and search experience right away. For example, when a user is shopping for a formal holiday party vs. a resort vacation, his long term preferences about the colors, patterns, brands etc. will be of little use for improving the overall shopping experience. Hence a system that learns about the user real time as the user is interacting with the site can deliver more pertinent results.

In one embodiment, on the online system, as the user is performing queries and doing clicks these are incorporated into a daily user profile. A summary of the preferences is created via kernel density estimation and is kept to be used in the ranking. As the user enters queries and clicks on item i, the feature vectors describing the properties of item i are fetched (from a precomputed table) and efficiently aggregated in a generative model of the daily user profile by on-line update of a kernel density estimator:

$$p ( {x}^{T} ) = \frac{1}{nh} {{\sum }_{i}}^{n} K ( \frac{{x}^{T} - {x}_{i}^{T}}{h} ) \qquad ( 3 )$$

where n is the number of click of the user's session, while h is the kernel bandwidth. The function p can be used to score the relevancy of an item feature vector x^{T} to the current session. A quadratic kernel may be used. After the user enters the query, all the items relevant to the query (visual and text based relevancy) are fetched from the item database along with the correspondent absolute rankings. The scores for each retrieved item are then computed according to the off-line and on-line models described above.

### CONCLUSION

Although numerous embodiments are described herein in terms of fashion products, alternative embodiments may extend to different types of products. In particular, embodiments may extend to other products that are generally classified by personal taste and appearance, such as furniture, carpets (and drapes), and design exteriors.

### CONCLUSION

Although illustrative embodiments have been described in detail herein with reference to the accompanying drawings, it is to be understood that the embodiments described are not limited to specific examples recited. As such, many modifications and variations are possible, including the matching of features described with one embodiment to another embodiment that makes no reference to such feature. Moreover, a particular feature described either individually or as part of an embodiment can be combined with other individually described features, or parts of other embodiments, even if the other features and embodiments make no mention of the particular feature.

What is claimed is:

1. A computer-implemented method for determining user preferences for fashion products, the method comprising:
using one or more processors to perform steps comprising:
programmatically determining a fashion preference of a user based on a user's interaction with a plurality of fashion product content items that individually depict a corresponding fashion product;
making a recommendation to a user of a fashion product based at least in part on the fashion preference of the user.

2. The computer-implemented method of claim 1, further comprising individual displaying the plurality of fashion product content items to the user, and prompting the user for a response that indicates a like or dislike of the plurality of fashion product content items.

3. The computer-implemented method of claim 1, wherein programmatically determining the fashion preference includes:
identifying a set of images that individually depict one or more fashion items;
displaying a sequence comprising a plurality of panels, in which each panel includes at least two images from the set to the user;
for each panel, recording a response from the user that indicates which of the at least two images in that panel the user most likes or most dislikes.

4. The computer-implemented method of claim 3, wherein displaying the sequence includes creating each panel so that each fashion product content item of the individual panels displays a corresponding fashion product that is of a corresponding genre that is different than the fashion product of the other fashion product content item of the panel.

5. The computer-implemented method of claim 4, wherein the fashion product content items of each panel are determined to belong to the corresponding genre by manual input.

6. The computer-implemented method of claim 1, further comprising prompting the user to provide input that specifies one or more known parameters about the user's fashion preference.

7. The computer-implemented method of claim 1, wherein the one or more known parameters include a size or a price preference of the user.

8. The computer-implemented method of claim 1, wherein making the recommendation to a user of the fashion product includes making the recommendation of one or more fashion products based on the determined fashion preference and known parameters of the user.

9. A computer-implemented method for using programmatic descriptors for fashion products, the method comprising:
using one or more processors to perform steps comprising:
analyzing a fashion product content item to determine a set of features of a fashion product depicted in the fashion product content item;
programmatically associating the fashion product to a pre-defined descriptive category for each of a plurality of descriptive classifications, based on a quantitative analysis of the determined set of features;
using the product content item and its pre-defined descriptive category for each of the plurality of descriptive classifications to determine or predict a user preference.

10. The method of claim 9, wherein the plurality of descriptive classifications include one or more of a genre class, a pattern class, a shape class, or a color family class.

11. The method of claim 9, wherein analyzing a fashion product content item includes performing image analysis on an image portion of the fashion product content item

12. The method of claim 9, wherein programmatically associating the fashion product to the pre-defined descriptive category includes determining a probability that the fashion product has a visual characteristic of each pre-defined category of one or more of the descriptive classifications.

13. The method of claim 9, wherein using the fashion product content item and its pre-defined descriptive category for each of the plurality of descriptive classifications includes detecting user selection or interaction with the fashion product content item, and using the pre-defined descriptive category of each of the descriptive classification in order to determine the user preference.

14. The method of claim 13, wherein detecting user selection or interaction with the fashion product content item includes monitoring which fashion product content items the user selects to view in order to determine a profile for that user based on the pre-defined descriptive category of the individual descriptive classifications for each product that the user viewed.

15. The method of claim 9, wherein using the fashion product content item and its pre-defined descriptive category for each of the plurality of descriptive classifications includes identifying a fashion genre or style preference of a user, and recommending, or not recommending, the fashion product based on the pre-defined descriptive categories associated with the fashion product content item and the fashion genre or style preference of the user.

16. The method of claim 9, further comprising:
recording historical information pertaining to a user's online activity about fashion products; and
determining the user's genre preferences for fashion products based in part on the historical information.

17. A computer-implemented method for determining user preferences for fashion products, the method comprising:
using one or more processors to perform steps comprising:
analyzing individual fashion product content items representing a catalog of fashion products to determine, for each fashion product content item, a set of features of a fashion product depicted in that fashion product content item;
programmatically associating each fashion product represented by one of the fashion product content items to a pre-defined descriptive category for each of a plurality of descriptive classifications, based on a quantitative analysis of the determined set of features;
detecting one or more fashion product content items that is deemed to be of interested to the user;
determining a fashion preference of the user using the pre-defined descriptive category for each of the plurality of descriptive classifications of the one or more fashion product content items that are deemed of interest to the user.

18. The method of claim 7, wherein determining the preference of the user includes using historical information that includes search terms previously used by the user.
